(19) United States
(12) Patent Application Publication
(10) Pub. No.: US 2026/0138683 A1
(43) Pub. Date: May 21, 2026

(54) Mounting Assembly for a Frontbox of a Vehicle

(71) Applicant: Daimler Truck AG, Leinfelden-Echterdingen (DE)

(72) Inventors: Sameer PUJAR, Pune (IN); Eswar KURUKUNDU, Dhone (IN)

(21) Appl. No.: 19/392,552

(22) Filed: Nov. 18, 2025

(30) Foreign Application Priority Data
Nov. 21, 2024 (IN) 202441090390

(51) Int. Cl. B62D 27/06; B60R 16/023; B62D 21/02; B62D 27/02

(52) U.S. Cl. CPC B62D 27/06; B60R 16/0238; B62D 21/02; B62D 27/023

(57) ABSTRACT

A mounting assembly for a frontbox of a vehicle includes at least two side frames removably mounted on front longitudinal beams of the vehicle. At least two pairs of first brackets are mounted on the at least two side frames. At least two plates are disposed horizontally between the two side frames. Each plate is removably mounted on the corresponding pair of first brackets such that each plate is configured to slide along a lateral direction of the vehicle. Each plate of the at least two plates has provisions to facilitate mounting of at least one control unit of the vehicle. The mounting assembly facilitates in ease of service and significant reduction of vehicle downtime.

### CROSS REFERENCE TO RELATED APPLICATION

This application claims priority under 35 U.S.C. § 119 from Indian Patent Application number 202441090390, filed Nov. 21, 2024, the entire disclosure of which is herein expressly incorporated by reference.

### BACKGROUND AND SUMMARY OF THE INVENTION

The following specification particularly describes the invention and the manner in which it is to be performed.

The present disclosure generally relates to the field of automobiles. Particularly, but not exclusively, the present disclosure relates to a frontbox of the vehicle, preferably electrical heavy duty vehicles. Further, embodiments of the present disclosure disclose a mounting assembly for the frontbox of the vehicle.

Increase in transportation of goods and movement of passengers, has led to a high demand for vehicles, especially commercial vehicles, and passenger vehicles. As road travel is the cheapest mode of travel, majority of the people prefer to travel through public vehicles, preferably buses. The vehicles, preferably heavy duty vehicles require more power to run driving wheels of the vehicle due to high amount of load. The power generation can be increased by increasing rate of combustion of fuels, for examplepetrol, diesel, gasoline and likewise in a power stroke of Internal combustion engines. The combustion of more fuel results in generation of more exhaust gases that tend to pollute the environment. In order to curb the pollution caused by burning of fuels, the vehicle industries are moving towards implementation of electric vehicles, that require current to drive a traction motor associated with the vehicle and the traction motor is connected to the driving wheels through a power transmission unit.

The implementation of traction motor to drive the vehicle may have resulted in lesser pollution. However, the operation of traction motor requires a precise control mechanism that governs proper and required actuation of the traction motor by regulating amount of current passed to the traction motor from a battery module. Most of the electric vehicles, preferably heavy duty electric vehicles, for exampleelectric buses, trucks and likewise, comprise a frontbox area or compartment disposed at a front portion of the vehicle. The frontbox compartment generally comprises a plurality of mounting means to facilitate mounting of different controllers, power boxes, circuits, busbars and likewise. However, the mounting of such components is often challenging to the vehicle manufactures, because of the packaging constraint present inside the frontbox, accessibility of such components disposed inside the frontbox and thereby difficulty in serviceability of such components mounting inside the frontbox.

Conventionally, vehicle manufacturers have sought, proposed, and implemented different solutions to address the above problem. One of the existing solutions include mounting of such electronic components on a vertical frame which in turn is fixed to a frontal chassis of the vehicle. The vertical mounting or orientation of the components may have facilitated packaging of components in a limited space, but such a vertical orientation of the components causes misalignment during service, damaging tapped holes, and thereby increasing vehicle downtime. The heavy cover plate during removal and assembly, and the cradle structure blocking access, further exacerbate these issues. The frontbox generally has two Variable Frequency Drive [VFD] units, but their access is blocked by surrounding components, especially of the bottom VFD. This results in additional downtime as a top VFD and other peripheral components must be removed to access the bottom VFD. The vertical mounting of the components may also exhibit uneven weight distribution, with more load concentrated on the RH side due to vertical placement of junction box and VFDs.

Some of the existing assemblies for frontbox of a vehicle are disclosed in CN utility patent no. CN206306808U [referred as '808 publication hereafter], CN utility patent no. CN215042597U [referred as '597 publication hereafter] and CN utility patent no. CN201530302U [referred as '302 publication hereafter].

The '808 publication discloses an electric vehicle that comprises a fixed suspension structure assembly. The assembly comprises vertical supports, for instance-upper mounting plates are bolted onto the vertical supports. The upper mounting plates serve as mounting base to facilitate mounting of the components associated with the vehicle, for examplemounting of the junction box. The '808 publication discloses the assembly that facilitates a mounting of the components in a vertical orientation and thereby may cause of the above mentioned problems, for exampleincrease in downtime of the vehicle, due to increase time in servicing of the vehicle, difficult in accessing the components that are positioned behind the other components, uneven weight distribution and likewise.

The '597 publication relates to a heavy-duty truck comprising a universal electric control integrated bracket, the high voltage box mounted on top, and a motor controller mounted on bracket. A mounting of a MCU bracket the design has vertical structural supports. The vertical structural supports have vertical mounting scheme on one side. The universal electric control structural is bolted to a longitudinal bar of vehicle. Similar to '808 publication, the '597 publication also discloses mounting of the components associated with the heavy duty truck in a vertical orientation and thereby may cause similar problems.

The '302 publication discloses an electric vehicle comprising a battery box structural assembly. The assembly comprises batteries which are mounted on top and bottom of a bracket. The assembly discloses vertical structural supports have vertical mounting schemes. The '302 publication does not disclose the specific mounting of the electronic components of the electric vehicle that aids in improving the serviceability of the vehicle and at the same time are easily accessible.

The prior arts described above, and other such known arts disclose different assemblies for mounting the components associated with the vehicle, preferably with the frontbox of the vehicle. However, such constructions do not provide a simplified assembly to facilitate easy accessibility of all the components improving the serviceability of the vehicle and simultaneously decreasing the downtime of the vehicle.

The present disclosure is directed to overcome one or more limitations stated above or any other limitations associated with the prior art.

One or more shortcomings of conventional assemblies are overcome, and additional advantages are provided through a mounting assembly for a frontbox of a vehicle as claimed in the present disclosure.

The present disclosure relates to a mounting assembly for a frontbox of a vehicle. The vehicle referred in the present disclosure may be defined as any vehicle, preferably heavy duty vehicle, more preferably commercial passenger vehicles, for example—buses. The vehicle referred in the present disclosure is specifically related to electric passenger bus that comprise plurality of seats to provide seating for the passengers. Alternatively, the assembly may be incorporated in different kind of vehicles, for example—trucks. The vehicle comprises a traction motor take consumes power from a power source of the vehicle in order to drive driving wheels of the vehicle. The vehicle further comprise the frontbox, alternatively defined as “frontbox structure” or “frontbox unit”, but not limited to the same. The frontbox comprises the assembly to facilitate mounting of plurality of components, preferably electronic components, for example—High Voltage Junction Box [HVJB], Variable Frequency Drives [VFDs], heat sink, Vehicle Control Unit [VCU] and likewise, associated with the vehicle, i.e., electric bus. The assembly comprises of provisions to facilitate horizontal mounting of the components one above another. The assembly further comprises at least one tray like structure that can be slid out individually and wouldn't need exclusive support as the tray design ensures the component is supported. The assembly facilitates in ease of service and significant reduction of vehicle downtime. The assembly provides a horizontal mounting of the components which facilitate in lowering the overall centre of gravity of the frontbox, which reduces lateral loads and thereby increases life of isolators (provided to absorb shocks or vibrations). The assembly may also improve operator safety while servicing the HVJB & VFDs, as the HVJB and VFDs will be laying flat on the assembly during service. The constructional features of the assembly facilitate in efficient space utilization to accommodate additional components on frontbox while also improving the serviceability.

Additional features and advantages are realized through the techniques of the present disclosure. Other embodiments and aspects of the disclosure are described in detail herein and are considered as a part of the claimed disclosure.

In one non-limiting embodiment of the present disclosure, a mounting assembly for a frontbox of a vehicle is disclosed. The assembly comprises at least two side frames removably mounted on front longitudinal beams of the vehicle. The assembly comprises at least two pairs of first brackets mounted on the at least two side frames. The assembly comprises at least two plates disposed horizontally between the two side frames, each plate being removably mounted on the corresponding pair of first brackets such that each plate is configured to slide along a lateral direction of the vehicle. Each plate of the at least two plates comprises provisions to facilitate mounting of at least one control unit of the vehicle.

In an embodiment, each side frame of the at least two side frames comprise a plurality of vertical members spaced apart from each other at a predefined distance. A horizontal member disposed at top of the plurality of vertical members. The horizontal member is rigidly connected to the plurality of vertical members of respective side frames.

In an embodiment, each vertical member of the plurality of vertical members comprises a bottom end welded with at least one of a horizontal mounting bracket and a vertical mounting bracket to facilitate removable mounting of the vertical members of respective side frames on the front longitudinal beams of the vehicle.

In an embodiment, the at least two pair of first brackets are angular brackets defined having an L-shaped structure and are bolted at different heights on the plurality of vertical members.

In an embodiment, at least one first bracket of the at least two pairs of first brackets comprises a vertically extending flange configured to abut with a rear edge of the plate mounted on the corresponding first brackets.

In an embodiment, the assembly comprises at least two upper mounting plates configured to hold and maintain a uniform distance between the at least two side frames.

In an embodiment, each upper plate of the at least two upper plates comprise provisions to facilitate removable mounting of a High Voltage Junction Box [HVJB] of the vehicle.

In an embodiment, the assembly comprises at least one reinforcing plate disposed between the at least two upper mounting plates.

In an embodiment, each side frame of the at least two side frames comprise an auxiliary mounting plate disposed between the plurality of vertical members in a vertical orientation to facilitate mounting of peripheral components of the frontbox of the vehicle.

In an embodiment, the assembly comprises a lift bracket extending in a vertically upward direction and offset from one of the at least two side frames. The lift bracket is adapted to receive a lifting anchor to displace the assembly from the frontbox of the vehicle to a worktable of a workstation.

It is to be understood that the aspects and embodiments of the disclosure described above may be used in any combination with each other. Several of the aspects and embodiments may be combined to form a further embodiment of the disclosure.

The foregoing summary is illustrative only and is not intended to be in any way limiting. In addition to the illustrative aspects and features described above, further aspects and features will become apparent by reference to the drawings and the following detailed description.

The novel features and characteristics of the disclosure are set forth in the appended claims. The disclosure itself, however, as well as a mode of use, further objectives, and advantages thereof, will best be understood with reference to the following detailed description of an embodiment when read in conjunction with reference to the accompanying drawings wherein like reference numerals represent like elements and in which:

### BRIEF DESCRIPTION OF THE DRAWINGS

FIG. 1 illustrates a perspective view of a mounting assembly mounted with components of a frontbox of a vehicle, in accordance with an embodiment of the present disclosure;

FIG. 2 illustrates a perspective view of the mounting assembly of FIG. 1 without any components being mounted thereon, in accordance with an embodiment of the present disclosure;

FIG. 3 illustrates an exploded view of the mounting assembly, in accordance with an embodiment of the present disclosure; and

FIG. 4 illustrates another perspective view of the mounting assembly of FIG. 1 depicting extended position of a plate of the assembly, in accordance with an embodiment of the present disclosure.

### DETAILED DESCRIPTION OF THE DRAWINGS

The figures depict embodiments of the disclosure for purposes of illustration only. One skilled in the art will readily recognize from the following description that alternative embodiments of the structures and methods illustrated herein may be employed without departing from the objectives of the disclosure described herein.

While the embodiments in the disclosure are subject to various modifications and alternative forms, specific embodiments thereof have been shown by way of example in the figures and will be described below. It should be understood, however, that it is not intended to limit the disclosure to the particular forms disclosed, but on the contrary, the disclosure is to cover all modifications, equivalents, and alternative falling within the scope of the disclosure.

It is to be noted that a person skilled in the art would be motivated from the present disclosure and modify the mounting assembly for a frontbox of a vehicle. However, such modifications should be construed within the scope of the disclosure. Accordingly, the drawings show only those specific details that are pertinent to understand the embodiments of the present disclosure, so as not to obscure the disclosure with details that will be readily apparent to those of ordinary skill in the art having benefit of the description herein. In the drawings neither the complete vehicle nor all components mounted to the frontbox of the vehicle have been shown for the purpose of simplicity.

The terms “comprises”, “comprising”, or any other variations thereof used in the disclosure, are intended to cover a non-exclusive inclusions, such that an assembly that comprises a list of components does not include only those components but may include other components not expressly listed or inherent to such assembly, method, or system, or device. In other words, one or more elements in an assembly or device proceeded by “comprises . . . a” does not, without more constraints, preclude the existence of other elements or additional elements in the system or device.

Embodiments of the present disclosure disclose a mounting assembly (hereinafter may be referred to as “assembly”) for a frontbox of a vehicle. The assembly may be equipped in vehicles for examplepassenger vehicles, commercial vehicles, heavy duty vehicles, and likewise. Preferably, the assembly is equipped in the heavy duty vehicles, for exampletrucks, buses, load carriers, etc, having the frontbox disposed at a front portion of the vehicle. In an exemplary embodiment, the mounting assembly and the constructional elements of the mounting assembly are equipped in electric buses defined having the frontbox. The frontbox may alternatively be referred as a “frontbox structure”, “frontbox structural unit”, “frontbox unit” and likewise. The frontbox structure comprises a plurality of provisions to facilitate mounting of components, control units associated with the vehicle. The frontbox structure is disposed below a driver cabin of the vehicle, i.e., electric buses, trucks and likewise.

The vehicle may comprise a chassis, preferably a ladder chassis to provide provisions for mounting a body or frame of the vehicle. The vehicle may comprise a front portion, a rear portion and an intermediate portion disposed between the front portion and the rear portion. The front portion may comprise a driver cabin, the frontbox and the components mounted within the frontbox of the vehicle. The intermediate portion may generally comprise a passenger compartment configured to provide provisions to facilitate seating of the passengers inside the vehicle. The rear portion may comprise a rear body of the vehicle mounted with tail lamps, indicators, reverse lamp and likewise. The frontbox may be defined as a mounting space disposed in the front portion of the vehicle and mounted above front longitudinal beams of the vehicle. The vehicle may comprise a power generating unit, preferably a traction motor to facilitate driving of the vehicle. The power generating unit may be disposed in the front portion of the vehicle, but not limited to the same. Alternatively, the power generating unit may be disposed at the rear portion of the vehicle.

The vehicle may comprise a power transmission unit coupled to the power generating unit. The power transmission unit may comprise a plurality of gears configured to vary output revolutions per minute (rpm), output power transmitted to driving wheels of the vehicle. The vehicle may also comprise a plurality of controllers to regulate or control rpm of the power generation unit, i.e., traction motor. The vehicle plurality of controllers may include—Variable Frequency Drives [VFDs], High Voltage Junction Box [HVJB], Electronic Control Units [ECUs] and likewise. The VFDs, HVJB and ECUs are positioned inside the frontbox of the vehicle. The assembly disclosed in the present disclosure facilitates efficient mounting of such controllers, i.e., VFDs, HVJB, ECUs and likewise, in the frontbox of the vehicle.

The assembly may comprise construction elements designed in such a way that the HVJB and the VFDs are mounted horizontally one above the other in a vertical stack formation. The assembly may comprise a unique drawer tray design where each component can be slid out individually and may not require dedicated support as the tray design ensures the component is supported. The tray design hereinafter referred as plates of the assembly. The entire assembly is bolted on the front longitudinal beams of the vehicle.

In an embodiment, the assembly comprises at least two side frames removably mounted on the front longitudinal beams of the vehicle. The assembly comprises at least two pairs of first brackets mounted on the at least two side frames. The assembly comprises at least two plates disposed horizontally between the two side frames, each plate being removably mounted on the corresponding pair of first brackets such that each plate is configured to slide along a lateral direction of the vehicle. Each plate of the at least two plates comprises provisions to facilitate mounting of at least one control unit of the vehicle. The control unit may be defined as Variable Frequency Drives [VFDs] of the vehicle. Each side frame of the at least two side frames comprises a plurality of vertical members spaced apart from each other at a predefined distance. A horizontal member disposed at top of the plurality of vertical members. The horizontal member is rigidly connected to the plurality of vertical members of respective side frames.

In an embodiment, each vertical member of the plurality of vertical members comprises a bottom end welded with at least one of a horizontal mounting bracket and a vertical mounting bracket to facilitate removable mounting of the vertical members of respective side frames on the front longitudinal beams of the vehicle. The at least two pair of first brackets are angular brackets defined having an L-shaped structure and are bolted at different heights on the plurality of vertical members. At least one first bracket of the at least two pairs of first brackets comprises a vertically extending flange configured to abut with a rear edge of the plate mounted on the corresponding first brackets. The assembly comprises at least two upper mounting plates configured to hold and maintain a uniform distance between the at least two side frames. Each upper plate of the at least two upper plates comprises provisions to facilitate removable mounting of the High Voltage Junction Box [HVJB] of the vehicle.

The assembly facilitates in ease of service and significant reduction of vehicle downtime. The assembly provides a horizontal mounting of the components which facilitate in lowering the overall centre of gravity of the frontbox, which reduces lateral loads and thereby increases life of isolators (provided to absorb shocks or vibrations). The assembly may also improve operator safety while servicing the HVJB & VFDs, as the HVJB and VFDs will be laying flat on the assembly during service. The constructional features of the assembly facilitate in efficient space utilization to accommodate additional components on frontbox while also improving the serviceability.

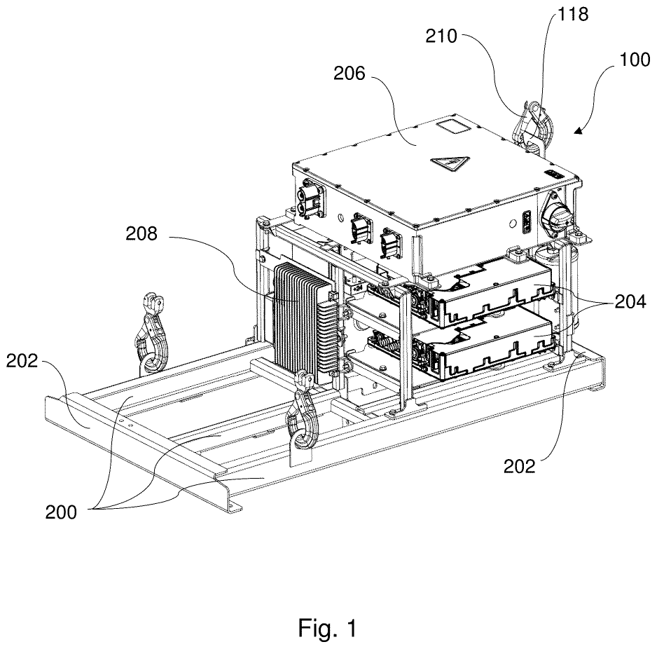

The following paragraphs describe the present disclosure with reference to FIGS. 1 to 4. In the figures, the same element or elements which have similar functions are indicated by the same reference signs.

FIG. 1 shows a mounting assembly (100) for a frontbox (not shown in Figs.) of a vehicle (not shown in Figs.), according to an embodiment of the present disclosure. The mounting assembly (100) may hereinafter be referred as “assembly”. The vehicle may herein generally refer to a commercial vehicle such as passenger carriers, goods carriers, heavy duty vehicles etc. In an exemplary embodiment of the present disclosure, the vehicle may be referred as electric buses, but not limited to the same. Alternatively, the assembly (100) is configured to be equipped in other heavy duty vehicles for exampletrucks. The assembly (100) is mounted in the vehicle in an appropriate location, preferably in a frontbox of the vehicle. The assembly (100) is configured to provide provisions to facilitate mounting of a plurality of components, preferably controller associated with the vehicle.

The frontbox is disposed at a front portion of the vehicle. The front portion may include a driver cabin disposed above the frontbox, at least two front wheels (not shown in Figs.) and a front body (not shown in Figs.) of the vehicle. The front body is provided with provisions to facilitate mounting of headlamps, fog lamps, indicators, sensors and likewise. The front body may comprise a flap (not shown in Figs.) configured to cover an opening defined by the frontbox. The flap is configured to be locked with the front body of the vehicle during driving conditions. The flap is configured to be unlocked and opened to access components mounted on the assembly (100). The vehicle may comprise a chassis to facilitate mounting of a body, including the front body, of the vehicle and other components, for example—the power generating unit, power storage unit, suspensions, wheels and likewise. The chassis may comprise front longitudinal beams (200) welded to at least two cross beams (202) of the vehicle. The cross beams (202) may extend from the front portion to a rear portion of the vehicle. The front longitudinal beams (200) facilitate in mounting of the assembly (100) associated with the front box of the vehicle.

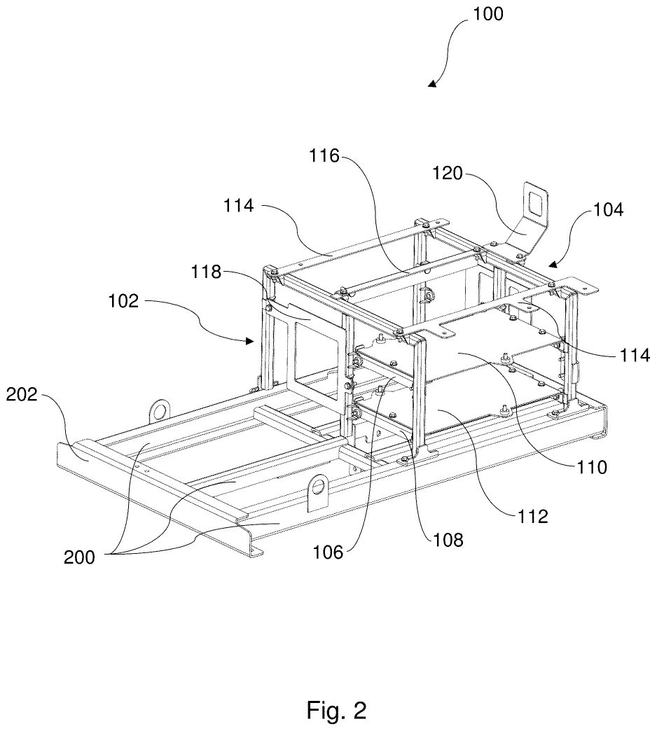

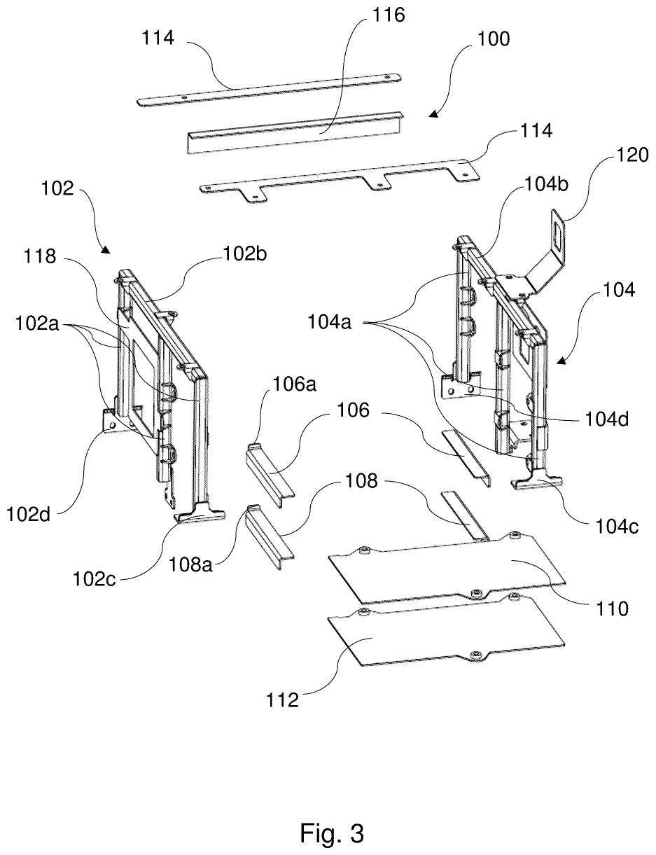

In an embodiment, the assembly (100) comprises at least two side frames (102, 104) removably mounted on the front longitudinal beams (200) of the vehicle. The at least two side frames (102, 104) may be defined as a left side frame and a right side frame. The left side frame is illustrated with reference numeral 102 and the right side frame is illustrated with reference numeral 104, as shown in FIG. 2 and FIG. 3. The at least two side frames (102, 104) are mounted on the front longitudinal beams (200) through a plurality of fastening members, for examplebolts and nuts along with washers. Alternatively, other connection methods may be implemented for joining or connecting the at least two side frames (102, 104) with the front longitudinal beams (200) of the vehicle. The side frames (102, 104) may alternatively be defined as frame structure, support members, frame members and likewise.

Referring to FIG. 3, each side frame of the at least two side frames comprise a plurality of vertical members (102a, 104a) and a horizontal member (102b, 104b). The plurality of vertical members (102a, 104a) are spaced apart from each other at a predefined distance. The predefined distance may vary depending on a gap between the front longitudinal beams (200) of the vehicle. In an exemplary embodiment, each side frame (102, 104) comprises three vertical members (102a, 104a), as shown in FIG. 3. The number of vertical members (102a, 104a) may vary depending on size of the assembly (100) and packaging constraint associated with the frontbox of the vehicle. The horizontal member (102b, 104b) is disposed at top of the vertical members (102a, 104a) of the respective side frames (102, 104). The horizontal member (102b, 104b) is rigidly connected to the plurality of vertical members (102a, 104a) of respective side frames (102, 104). The horizontal member (102b, 104b) may be attached to the plurality of vertical members (102a, 104a) through welding to form a rigid structure of the respective side frames (102, 104). The left side frame (102) may comprise the plurality of vertical members illustrated with reference numeral 102a and the right side frame (104) may comprise the plurality of vertical members illustrated with reference numeral 104a. The horizontal member (102b) is rigidly attached or connected to the plurality of vertical members (102a) of the left side frame (102) and the horizontal member (104b) is rigidly attached or connected to the plurality of vertical members (104a) of the left side frame (104), as shown in FIG. 3.

Each vertical member of the plurality of vertical members (102a, 104a) comprises a bottom end welded with at least one of a horizontal mounting bracket (102c, 104c) and a vertical mounting bracket (102d, 104d) to facilitate removable mounting of the vertical members (102a, 104a) of respective side frames (102, 104) on the front longitudinal beams (200) of the vehicle. In an exemplary embodiment, The horizontal mounting bracket (102c) are welded to the vertical members (102a) of the left side frame (102) and the horizontal mounting bracket (104c) are welded to the vertical members (104a) of the right side frame (104). The implementation of horizontal mounting brackets (102c, 104c) and the vertical mounting brackets (102d, 104d) span across the front longitudinal beams (200) laterally which eliminates the need of tight tolerances and thereby reducing the manufacturing cost of the vehicle. The horizontal mounting brackets (102c, 104c) and the vertical mounting brackets (102d, 104d) are defined with a plurality of holes adapted to receive fasteners to facilitate removable mounting of the side frames (102, 104) on the front longitudinal beams (200) of the vehicle.

In an exemplary embodiment, the assembly (100) comprises at least two pairs of first brackets (106, 108) mounted on the at least two side frames (102, 104). The at least two pairs of first brackets (106, 108) are removably mounted along a length of the respective vertical members (102a, 104a) of the side frames (102, 104). The at least two pair of first brackets (106, 108) are angular brackets defined having an L-shaped structure and are bolted at different heights on the plurality of vertical members (102a, 104a). The at least one first bracket of the at least two pairs of first brackets (106, 108) comprises a vertically extending flange (106a, 108a), as shown in FIG. 3.

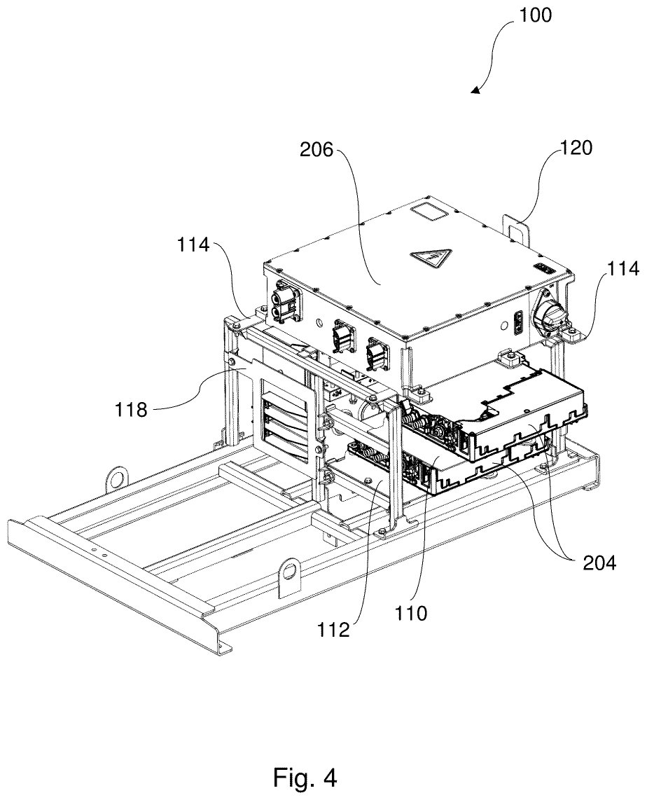

In an exemplary embodiment, the assembly (100) comprises at least two plates (110, 112) disposed horizontally between the two side frames (102, 104). Each plate being removably mounted on the corresponding pair of first brackets (106, 108) such that each plate is configured to slide along a lateral direction of the vehicle. Each plate of the at least two plates (110, 112) comprise provisions to facilitate mounting of at least one control unit (204) of the vehicle, as shown in FIG. 4. The control unit (204) may be defined as a Variable Frequency Drive [VFD] of the vehicle. The vertical extending flange (106a, 108a) of the first brackets (106, 108) is configured to provide easy assembling of the plates (110, 112) on respective pair of first brackets (106, 108), by limiting excess movement of the plates (110, 112) in a rearward direction. The vertical extending flange (106a, 108a) is also configured to ensure control units are easily located for assembly. The vertical extending flange (106a, 108a) is configured to arrest motion of control units while sliding them in lateral direction of vehicle so that the mounting holes on the control units align with mounting holes on the pair of first brackets (106, 108). The vertical extending flange (106a, 108a) is configured to abut with a rear edge of the plate mounted on the corresponding first brackets (106, 108). Each plate (110, 112) may be defined with provisions to facilitate sliding of the plate along a length of the corresponding first brackets (106, 108), which in turn provide support to the control unit (204) placed on the corresponding plate (110, 112). The sliding movement of the plate or drawer type plate of the assembly facilitates in complete accessibility to individual control unit and thereby eliminates the requirement of disassembling any other peripheral components to access the control unit. The plates may alternatively be defined as “trays”, “drawers” or likewise.

Once again referring to FIG. 2 and FIG. 3, the assembly (100) comprises at least two upper mounting plates (114) configured to hold and maintain a uniform distance between the at least two side frames (102, 104). Each upper mounting plate of the at least two upper mounting plates (114) comprises provisions to facilitate removable mounting of a High Voltage Junction Box [HVJB] (206) of the vehicle, as shown in FIG. 4. The plates (110, 112) and the upper mounting plates (114) may be manufactured from a metal alloy to provide strength and support to the control unit (204) and HVJB (206) respectively. The control unit (204) and the HVJB (206) may removably be mounted on the plates (110, 112) and the upper mounting plates (114) through fasteners. The assembly (100) comprises at least one reinforcing plate (116) disposed between the at least two upper mounting plates (114), as shown in FIG. 2. The reinforcing plate (116) provides additional support to the HVJB (206) and thereby prevent any unintentional movement of the HVJB (206) during driving the vehicle. Each side frame of the at least two side frames (102, 104) comprise an auxiliary mounting plate (118) disposed between the plurality of vertical members (102a, 104a) in a vertical orientation. The auxiliary mounting plate (118) is configured to facilitate mounting of peripheral components of the frontbox of the vehicle. In an exemplary embodiment, the auxiliary mounting plate (118) facilitates mounting of the peripheral components, for exampleVehicle Control Unit [VCU] (208), in a vertical orientation, as shown in FIG. 1. The assembly (100) further comprises a lift bracket (120) extending in a vertically upward direction and offset from one of the at least two side frames (102, 104), as shown in FIGS. 2-4. The lift bracket (120) is adapted to receive a lifting anchor (210) to displace the assembly (100) from the frontbox of the vehicle to a worktable of a workstation. The assembly may also comprise isolators (not shown in Figs.) to absorb vibrations and prevent vibrations from reaching to the control unit (204) or HVJB (206) mounted on the assembly (100).

In an embodiment of the present disclosure, the assembly facilitates in ease of service and significant reduction of vehicle downtime.

In an embodiment of the present disclosure, the assembly provides a horizontal mounting of the components which facilitate in lowering the overall centre of gravity of the frontbox, which reduces lateral loads and thereby increases life of isolators (provided to absorb shocks or vibrations).

In an embodiment of the present disclosure, the assembly may also improve operator safety while servicing the HVJB & VFDs, as the HVJB and VFDs will be laying flat on the assembly during service.

In an embodiment of the present disclosure, the constructional features of the assembly facilitate in efficient space utilization to accommodate additional components on frontbox while also improving the serviceability.

It is to be understood that a person of ordinary skill in the art may develop a device of similar configuration of mounting assembly without deviating from the scope of the present disclosure. Such modifications and variations may be made without departing from the scope of the present invention. Therefore, it is intended that the present disclosure covers such modifications and variations provided they come within the ambit of the appended claims and their equivalents.

### EQUIVALENTS

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE CHARACTERS

| | |
|---|---|
| Mounting assembly | 100 |
| Side frames | 102, 104 |
| Vertical members of side frames | 102a, 104a |
| Horizontal member of side frames | 102b, 104b |
| Horizontal mounting brackets | 102c, 104c |
| Vertical mounting brackets | 102d, 104d |
| Pair of first brackets | 106, 108 |
| Plates | 110, 112 |
| Upper mounting plates | 114 |
| Reinforcing plate | 116 |
| Auxiliary mounting plate | 118 |
| Lift bracket | 120 |
| Front longitudinal beams | 200 |
| Cross beams | 202 |
| Control unit | 204 |
| High Voltage Junction Box | 206 |
| Vehicle Control Unit | 208 |
| Lifting anchor | 210 |

What is claimed is:

1. A mounting assembly (100) for a frontbox of a vehicle, comprising:
at least two side frames (102, 104) removably mounted on front longitudinal beams (200) of the vehicle;
at least two pairs of first brackets (106, 108) mounted on the at least two side frames (102, 104); and
at least two plates (110, 112) disposed horizontally between the at least two side frames (102, 104), wherein the at least two plates (110, 112) are removably mounted on a respective pair of the at least two pairs of first brackets (106, 108) such that each of the at least two plates (110, 112) is slidable along a lateral direction of the vehicle;
wherein each of the at least two plates (110, 112) comprises a respective provision to facilitate mounting of at least one control unit (204) of the vehicle.

2. The mounting assembly (100) as claimed in claim 1, wherein each side frame of the at least two side frames (102, 104) comprises:
a respective plurality of vertical members (102a, 104a) spaced apart from each other at a predefined distance; and
a respective horizontal member (102b, 104b) disposed at a top of the respective plurality of vertical members (102a, 104a), wherein the respective horizontal member (102b, 104b) is rigidly connected to the respective plurality of vertical members (102a, 104a).

3. The mounting assembly (100) as claimed in claim 2, wherein each vertical member of the plurality of vertical members (102a, 104a) comprises a bottom end welded with a respective horizontal mounting bracket (102c, 104c) and a respective vertical mounting bracket (102d, 104d) to facilitate removable mounting of the plurality of vertical members (102a, 104a) on the front longitudinal beams (200) of the vehicle.

4. The mounting assembly (100) as claimed in claim 2, wherein the at least two pairs of first brackets (106, 108) are angular brackets defined having an L-shaped structure and are bolted on the plurality of vertical members (102a, 104a) at a respective height and wherein the respective height differs from each other.

5. The mounting assembly (100) as claimed in claim 4, wherein at least one first bracket of the at least two pairs of first brackets (106, 108) comprises a vertically extending flange (106a, 108a) configured to abut with a rear edge of the respective plate (110, 112) that is mounted on the at least two pairs of first brackets (106, 108).

6. The mounting assembly (100) as claimed in claim 4, further comprising at least two upper mounting plates (114) configured to hold and maintain a uniform distance between the at least two side frames (102, 104).

7. The mounting assembly (100) as claimed in claim 6, wherein each upper mounting plate of the at least two upper mounting plates (114) comprises a respective provision to facilitate removable mounting of a High Voltage Junction Box [HVJB] (206) of the vehicle.

8. The mounting assembly (100) as claimed in claim 6, further comprising at least one reinforcing plate (116) disposed between the at least two upper mounting plates (114).

9. The mounting assembly (100) as claimed in claim 2, wherein each side frame of the at least two side frames (102, 104) comprises a respective auxiliary mounting plate (118) disposed between the respective plurality of vertical members (102a, 104a) in a vertical orientation to facilitate mounting of peripheral components of the frontbox of the vehicle.

10. The mounting assembly (100) as claimed in claim 1, further comprising:
a lift bracket (120) extending in a vertically upward direction and offset from one of the at least two side frames (102, 104);
wherein the lift bracket (120) is configured to receive a lifting anchor (210) to displace the mounting assembly (100) from the frontbox of the vehicle to a worktable of a workstation.
